(19) United States
(12) Patent Application Publication
(10) Pub. No.: US 2013/0028086 A1
(43) Pub. Date: Jan. 31, 2013

(54) System and Method for Selecting Routing and Cancelling Overloading in Multihop Cellular Systems

(71) Applicants: Tsan-Ming Wu, Tao-Yuan (TW); Szu-Liang Wang, Tao-Yuan (TW)

(72) Inventors: Tsan-Ming Wu, Tao-Yuan (TW); Szu-Liang Wang, Tao-Yuan (TW)

(73) Assignee: CHUNG YUAN CHRISTIAN UNIVERSITY, Tao-Yuan (TW)

(21) Appl. No.: 13/230,968

(22) Filed: Sep. 13, 2011

(30) Foreign Application Priority Data
Jul. 28, 2011 (TW) 100126844

(51) Int. Cl. H04W 40/00; H04W 24/00; H04L 12/26

(52) U.S. Cl. 370/235

(57) ABSTRACT

A method for selecting routing and cancelling overloading in multihop cellular systems is provided herein. The method includes finding a user group having several routing selections in an overloading relay station, finding a user having maximum routing selections in the user group, disconnecting the routing link between the overloading relay station and the user to reduce the use of bandwidth of the overloading relay station, and finding an optimal routing from at least one un-overloading relay station group to link the user.

### BACKGROUND OF THE INVENTION

1. Field of the Invention

This invention generally relates to the field of communication systems, and more particularly, to a method and system for selecting routing and cancelling overloading in multihop cellular systems.

2. Description of the Prior Art

In traditional cellular systems, the base station (BS) executes signal processing by its own antennae for each user, but its coverage area and frequency resources are limited.

In response to a demand for next generation cellular systems to support high data rates, enlarge the coverage area, and provide good quality of service (QoS) for multimedia applications, Dixit et at have put their efforts in integrating the multihop relay technique into the cellular system for investigating the routing and topology issues (S. Dixit, E. Yanmaz, and O. K. Tonguz, “On the design of self-organized cellular wireless networks,” IEEE Commun. Mag., vol. 43, pp. 86-93, July 2005.) In a multihop cellular system, a user can either connect to the BS directly, or via relay stations (RSs). Consequently, it is possible to accommodate more transmission routes to increase the system capacity. However, this may be influenced by the RS overloading problem, whose congestion occurs owing to a large number of users requesting the same RS for service simultaneously.

Existing overloading relief may be loosely divided into two categories. One is the dynamic balance of the load, whose mathematical theory is illustrated in O. K. Tonguz and E. Yanmaz, “The mathematical theory of dynamic load balancing in cellular networks,” IEEE Trans. Mobile Comput., vol. 7, pp. 1504-1518, December 2008, and the other is the reduction of the data rate, a sub-optimal solution since its optimum throughput is proven to be NP-hard (Y. Liu, R. Hoshyar, X. Yang, and R. Tafazolli, “Integrated radio resource allocation for multihop cellular networks with fixed relay stations,” IEEE J. Sel. Areas Commun., vol. 24, pp. 2137-2146, November 2006.) The former scheme is applicable when the old channel condition between the served user and the overloaded RS is similar to the new one between the served user and the unoverloaded RS, thus the served user will shift completely the volume of the transmitting data from the old RS to the new one. However, when the unoverloaded RS locates too far away or the new channel has enormous interference or deep fades, the served user may need larger capacity from the new RS for supporting the same quality transmission, and this would make the new RS to change its status from unoverloading to overloading.

In view of the drawbacks mentioned with the prior art of the method for cancelling overloading, there is a continuous need to develop a new and improved method that overcomes the shortages associated with the prior art of the method for cancelling overloading. The advantages of the present invention are that it solves the problems mentioned above.

### SUMMARY OF THE INVENTION

In accordance with the present invention, a method and system for routing selection and overloading cancellation in multihop cellular systems substantially obviates one or more of the problems resulted from the limitations and disadvantages of the prior art mentioned in the background.

One of the purposes of this invention is to reduce the use of bandwidth of an overloading relay station by disconnecting the transmission link between the overloading relay station and the user(s) thereof, whereby to exclude the overloading relay station from the overloading status.

Another purpose of this invention is to reduce the use of bandwidth of an overloading relay station by decreasing the bandwidth of the user of the overloading relay station, whereby to solve the overloading problem for the overloading relay station.

Still another purpose of this invention is to provide an optimal routing to a user to link to, wherein the user disconnects the transmission routing from an overloading relay station.

The present invention provides a method for selecting routing and cancelling overloading in multihop cellular systems. The method includes (a) finding a user group having a plurality of routing selections from an overloading relay station, wherein the number of user in the user group is not zero; (b) finding a user having maximum routing selections from the user group, wherein the routing selections of the user include at least one un-overloading relay station group; (c) disconnecting the routing link between the overloading relay station and the user to reduce the use of bandwidth of the overloading relay station; and (d) finding an optimal routing from the at least one un-overloading relay station group to link the user.

The present invention further discloses a system for selecting routing and cancelling overloading in multihop cellular systems. The system includes a plurality of relay stations linking with a base station to form a multihop cellular network. Wherein, when at least one relay station in the plurality of relay stations is overloaded, the system performs the steps as follows (a) finding a user group having a plurality of routing selections from the at least one relay station, wherein the number of user in the user group is not zero; (b) finding a user having maximum routing selections from the user group, wherein the routing selections of the user include at least one un-overloading relay station group; (c) disconnecting the routing link between the at least one relay station and the user to reduce the use of bandwidth of the at least one relay station; and (d) finding an optimal routing from the at least one un-overloading relay station group to link the user.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 illustrates one preferred system embodiment in accordance with the present invention;

FIG. 2 illustrates one preferred flowchart in accordance with the present invention;

FIG. 3A depicts the comparisons of the system capacity in terms of users for one embodiment of this invention, IRRA, and iCAR schemes with a system bandwidth of 300 MHz;

FIG. 3B depicts the comparisons of the transmission power regarding number of users for one embodiment of this invention, IRRA, and iCAR algorithms; and

FIG. 3C shows the comparisons of the outage probability regarding number of users for one embodiment of this invention, IRRA, and iCAR designs.

### DETAILED DESCRIPTION OF THE PREFERRED EMBODIMENTS

Some embodiments of the present invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

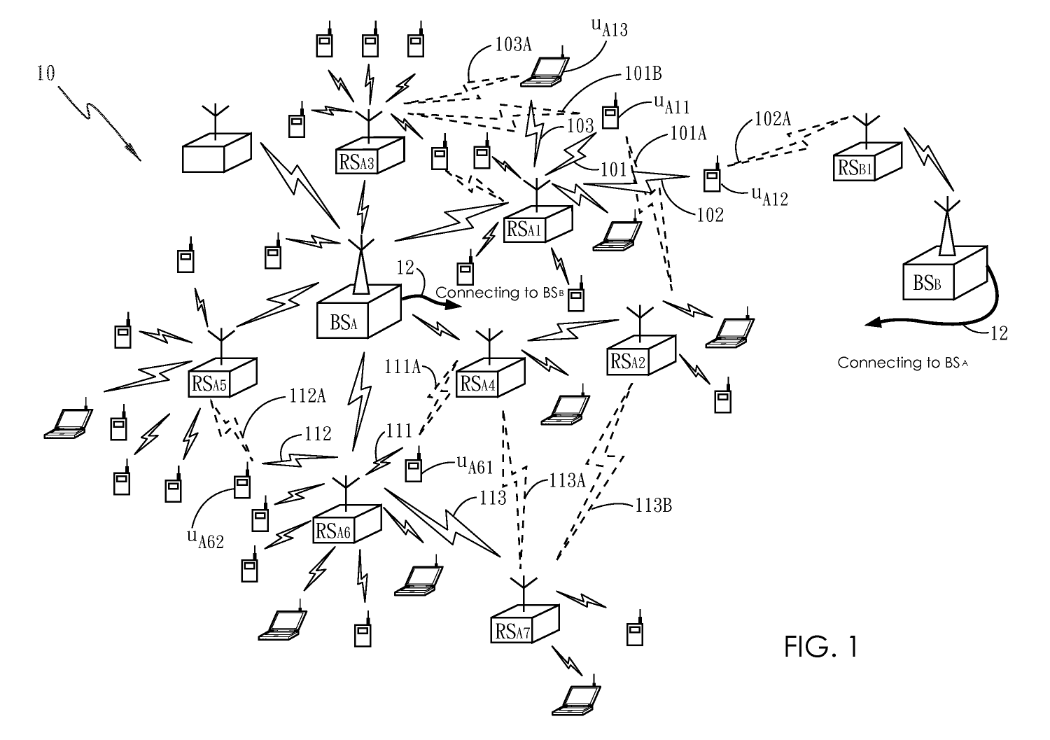

Referring to FIG. 1, a preferred system embodiment 10 in accordance with the present invention is illustrated. Two base stations BS_{A} and BSB have different service areas. Both of them, herein, could be the same system or different system, and are connected by a backbone 12. Several relay stations, such as RS_{A1}, RS_{A2}, RS_{A3}, RS_{A4}, RS_{A5}, RS_{A6}, RS_{A7}, and RS_{B1}, correspondingly locate in the service areas of the base stations BS_{A} and BS_{B}, and link with the base stations BS_{A} and BS_{B}. Hereinafter, the inventor only uses the embodiment of FIG. 1 as one sample explanation for the present invention. However, when the system of this invention is fulfilled in practice and has more base stations and relay stations, its operations should be the same as the embodiment described in FIG. 1, and this part can be obvious to those skilled in the art after they read the disclosure of this invention. Thus, the operations for the system of this invention with more base stations and relay stations will not be described.

Referring to FIG. 1 again, the relay stations RS_{A1}, RS_{A5}, and RS_{A6} are assumed that they are overloaded, and thus they are recorded in an overloading list by the base station BS_{A} to form a set of overloading relay station. First, the relay station RS_{A1} finds a user group with several routing selections from its users, in this embodiment, the user group has a user u_{A11} with 3 routing selections 101, 101A, and 101B, a user u_{A12} with 2 routing selections 102 and 102A, and a user u_{A13} with 2 routing selections 103 and 103A. Next, the relay station RS_{A1} finds a user having maximum routing selections from the user group, for example, the user u_{A11} in this case. Wherein, the routing selections of the user u_{A11} have at least one un-overloading relay station to form an un-overloading relay station group, such as the relay stations RS_{A2} and RS_{A3}. Then, the relay station RS_{A1} disconnects the routing link 101 between the relay station RS_{A1} and the user u_{A11} to reduce the use of bandwidth of the relay station RS_{A1}, whereby to solve the overloading problem. And finally, the user u_{A11} finds an optimal routing from the un-overloading relay station group, such as the relay stations RS_{A2} and RS_{A3}, to link to. In this embodiment, the user u_{A11} can select either a routing link 101A to link to the relay station RS_{A2} or a routing link 101B to link to the relay station RS_{A3}. The user u_{A11} chooses the routing link 101A linking with the relay station RS_{A2} as the optimal routing since the routing link 101A linking with the relay station RS_{A2} provides better communication status than the routing link 101B linking with the relay station RS_{A3} does, for example, the relay station RS_{A2} can offers the bandwidth required by the user u_{A11}, but the relay station RS_{A3} can only provides a part of bandwidth required by the user u_{A11}.

The inventor would like to stress that the user u_{A11} selects the optimal routing based on an optimal communication channel. In some cases, the optimal routing could be the shortest routing, such as linking to the base station BS_{A} through the routing link 101B and the relay station RS_{A3}. In other cases, such as those mentioned above, the optimal routing could not be the shortest routing, for example, linking to the base station BS_{A} through the routing link 101A, the relay station RS_{A2}, and the relay station RS_{A4}. Further, the optimal routing selection for the user u_{A11} could be determined by the steps as follows:

Comparing the time (a first time) for the user u_{A11} passing through the routing link (a first routing) of the relay station RS_{A1} and the time (a second time) for the user u_{A11} passing through the routing link (a second routing) of the relay station RS_{A2}, when the difference between the first time and the second time is smaller than a predetermined threshold, the routing link of the relay station RS_{A2} is the optimal routing for the user u_{A11}.

Besides, when the relay station RS_{A1} disconnects the routing link 101 from the user u_{A11}, the relay station RS_{A1} excludes the user u_{A11} from its users, and the user u_{A11} also removes the relay station RS_{A1} from its routing selections.

Referring to FIG. 1 again, if the relay station RS_{A1} is still in overloading status after it disconnects the routing link 101 of the user u_{A11}, the relay station RS_{A1} refinds a user group with several routing selections from its users, in this time, the user group has only the user u_{A12} with 2 routing selections 102 and 102A, and the user u_{A13} with 2 routing selections 103 and 103A since the user u_{A11} is excluded from the users of the relay station RS_{A1}. Next, the relay station RS_{A1} find a user having maximum routing selections from the user group, e.g. taking the user u_{A12} for a sample. Wherein, the routing selections of the user u_{A12} have at least one un-overloading relay station to form an un-overloading relay station group, such as the relay station RS_{B1}. Then, the relay station RS_{A1} disconnects the routing link 102 between the relay station RS_{A1} and the user u_{A12} to reduce the use of bandwidth of the relay station RS_{A1}, whereby to solve the overloading problem. And finally, the user u_{A12} finds an optimal routing from the un-overloading relay station group, such as the relay station RS_{B1}, to link to. In this time, the user u_{A12} can only select a routing link 102A to link to the relay station RS_{B1}.

The inventor would like to emphasize that the optimal routing selection, such as for the user u_{A12}, should not be limited at the relay stations within the service area of the same base station BS_{A}, the optimal routing selection could be the relay station(s), such as the relay station RS_{B1}, within the different service areas of the different base stations, for example, the base station BS_{B}.

Likewise, when the relay station RS_{A1} disconnects the routing link 102 from the user u_{A12}, the relay station RS_{A1} excludes the user u_{A12} from its users, and the user u_{A12} excludes the relay station RS_{A1} from its routing selections as well.

Referring to FIG. 1 again, if the relay station RS_{A1} is in un-overloading status after it respectively disconnects the routing links 101 and 102 from the users u_{A11} and u_{A12}, the relay station RS_{A1} is removed from the overloading list mentioned above by the base station BS_{A}. That is, the relay station RS_{A1} is excluded from the set of overloading relay station. The user u_{A13} keeps the routing link 103A linking to the relay station RS_{A1} because the relay station RS_{A1} is not in overloading status.

Referring to FIG. 1 again, if the set of overloading relay station is not empty (for example, the relay stations RS_{A5} and RS_{A6} are still overloaded) after the base station BS_{A} excludes the relay station RS_{A1} from the overloading list, the relay station RS_{A5} finds a user group with several routing selections from its users, in this case, the relay station RS_{A5} cannot find the user group because each of its users has only one individual routing, and hence, the number of the user group is zero. Next, the relay station RS_{A5} finds a user using a maximum bandwidth from its users and reduce the bandwidth of the user using the maximum bandwidth to decrease the use of bandwidth of the relay station RS_{A5}, whereby to exclude the relay station RS_{A5} from overloading status.

To reduce the bandwidth of the user using the maximum bandwidth, it can be implemented by the steps as follows: reducing the bandwidth of the user using the maximum bandwidth by a predetermined value to decrease the use of bandwidth of the relay station RS_{A5} or multiplying the bandwidth of the user using the maximum bandwidth by a predetermined percentage to reduce the use of bandwidth of the relay station RS_{A5}.

If the overloading problem of the relay station RS_{A5} is completely solved (e.g. the bandwidth capacity of the relay station RS_{A5} is bigger than the use of bandwidth required by all its users) after the relay station RS_{A5} reduces the bandwidth of the user using the maximum bandwidth, the relay station RS_{A5} is removed from the overloading list by the base station BS_{A}. In other words, the relay station RS_{A5} is excluded from the set of overloading relay station.

Referring to FIG. 1 again, if the set of overloading relay station is not empty yet (e.g. the relay station RS_{A6} is still in overloading status) after the base station BS_{A} removes the relay stations RS_{A1} and RS_{A5} from the overloading list, the relay station RS_{A6} finds a user group with several routing selections from its users, in this case, the user group has a user u_{A61} with 2 routing selections 111 and 111A, the user u_{A62} with 2 routing selections 112 and 112A, and the relay station RS_{A7} with 3 routing selections 113, 113A, and 103B. Next, the relay station RS_{A6} finds a user having maximum routing selections from the user group, for example, the relay station RS_{A7} in this case. Wherein, the routing selections of the relay station RS_{A7} have at least one un-overloading relay station to form an un-overloading relay station group, such as the relay stations RS_{A2} and RS_{A4}. Then, the relay station RS_{A6} disconnects the routing link 113 between the relay station RS_{A6} and the relay station RS_{A7} to reduce the use of bandwidth of the relay station RS_{A6}, whereby to solve the overloading problem. Finally, the relay station RS_{A7} finds an optimal routing from the un-overloading relay station group, such as relay stations RS_{A2} and RS_{A4}, to link with. In this case, the relay station RS_{A7} can select either a routing link 113B to link to the relay station RS_{A2} or a routing link 113A to link to the relay station RS_{A4}. The relay station RS_{A7} is assumed that it chooses the routing link 113A linking with the relay station RS_{A4} as the optimal routing because the routing link 113A linking with the relay station RS_{A4} provides better communication status than the routing link 113B linking with the relay station RS_{A2} does, for example, the transmission attenuation by the relay station RS_{A4} is smaller than by the relay station RS_{A2} or the communication channel interference by the relay station RS_{A4} is smaller than by the relay station RS_{A2}, etc.

The inventor would like to emphasize that the relay station RS_{A7} selects the optimal routing also based on an optimal communication channel. In this case, the optimal routing meets the shortest routing (e.g. linking to the base station BS_{A} through the routing link 113A and the relay station RS_{A4}), but not limit to. Further, the optimal routing selection for the relay station RS_{A7} can be fulfilled according to the optimal routing selection for the user u_{A11} mentioned before, and this part is obvious to those skilled in the art by reading this disclosure and would not be repeated here. The inventor also would like to clarify that the user and the user group mentioned in this invention should not be limited in end-user communication devices and they could be relay communication tools as well. In this invention, the user and the user group include communication devices and/or relay stations, such as the relay station RS_{A7} in this case.

Similarly, when the relay station RS_{A6} disconnects the routing link 113 from the user (the relay station RS_{A7}), the relay station RS_{A6} excludes the relay station RS_{A7} from its users, and the relay station RS_{A7} also excludes the relay station RS_{A6} from its routing selections.

Referring to FIG. 1 again, if the relay station RS_{A6} is still in overloading status after it disconnects the routing link 113 from the relay station RS_{A7}, the relay station RS_{A6} refinds a user group with several routing selections from its users, in this time, the user group has only user u_{A61} with 2 routing selections 111 and 111A, and user u_{A62} with 2 routing selections 112 and 112A since the relay station RS_{A7} is excluded from the users of the relay station RS_{A6}. Next, the relay station RS_{A6} finds a user having maximum routing selections from the user group, in this case, taking the user u_{A61} for a sample. Wherein, the routing selections of the user u_{A61} have at least one un-overloading relay station to form an un-overloading relay station group, such as the relay station RS_{A4}. Then, the relay station RS_{A6} disconnects the routing link 111 between the relay station RS_{A6} and the user u_{A61} to reduce the use of bandwidth of the relay station RS_{A6}, whereby to solve the overloading problem. And finally, the user u_{A61} finds an optimal routing from the un-overloading relay station group, such as the relay station RS_{A4}, to link to. In this time, the user u_{A61} can only select the routing link 111A to link with the relay station RS_{A4}.

In the same way, when the relay station RS_{A6} disconnects the routing link 111 from the user u_{A61}, the relay station RS_{A6} excludes the user u_{A61} from its users, and the user u_{A61} also excludes the relay station RS_{A6} from its routing selections.

Referring to FIG. 1 again, if the relay station RS_{A6} is still in overloading status after it disconnects the routing links 113 and 111 respectively from the relay station RS_{A7} and the user u_{A61}, the relay station RS_{A6} refinds a user group with several routing selections from its users, in this time, the user group has only the user u_{A62} with 2 routing selections 112 and 112A since the relay station RS_{A7} and the user u_{A61} are excluded from the users of the relay station RS_{A6}. However, because the routing link 112A of the user u_{A62} has no at least one un-overloading relay station (for example, assumed that the relay stations RS_{A5} is in overloading status), the relay station RS_{A6} finds a user using a maximum bandwidth in its users and reduces the bandwidth of the user using the maximum bandwidth to decrease the use of bandwidth of the relay station RS_{A6}, whereby to exclude the relay station RS_{A6} from overloading status.

To reduce the bandwidth of the user using the maximum bandwidth, it can be realized by the steps of reducing the bandwidth of the relay station RS_{A5}'s user using the maximum bandwidth mentioned before, and this part is obvious to those skilled in the art after reading this disclosure and would not be repeated here.

If the overloading problem of the relay station RS_{A6} is completely solved (e.g. the bandwidth capacity of the relay station RS_{A6} is bigger than the use of bandwidth required by all its users) after the relay station RS_{A6} disconnects the routing links 113 and 111 correspondingly from the relay station RS_{A7} and the user u_{A61} and reduces the bandwidth of the user using the maximum bandwidth, the relay station RS_{A6} is removed from the overloading list by the base station BS_{A}. In other words, the relay station RS_{A6} is excluded from the set of overloading relay station.

Until now, the set of overloading relay station of the preferred embodiment illustrated in FIG. 1 is empty after the base station BS_{A} removes the relay stations RS_{A1}, RS_{A5}, and RS_{A6} from the overloading list successively. That is, the overloading problems in the preferred embodiment of FIG. 1 are completely solved and there is no relay station in overloading status within this multihop cellular system.

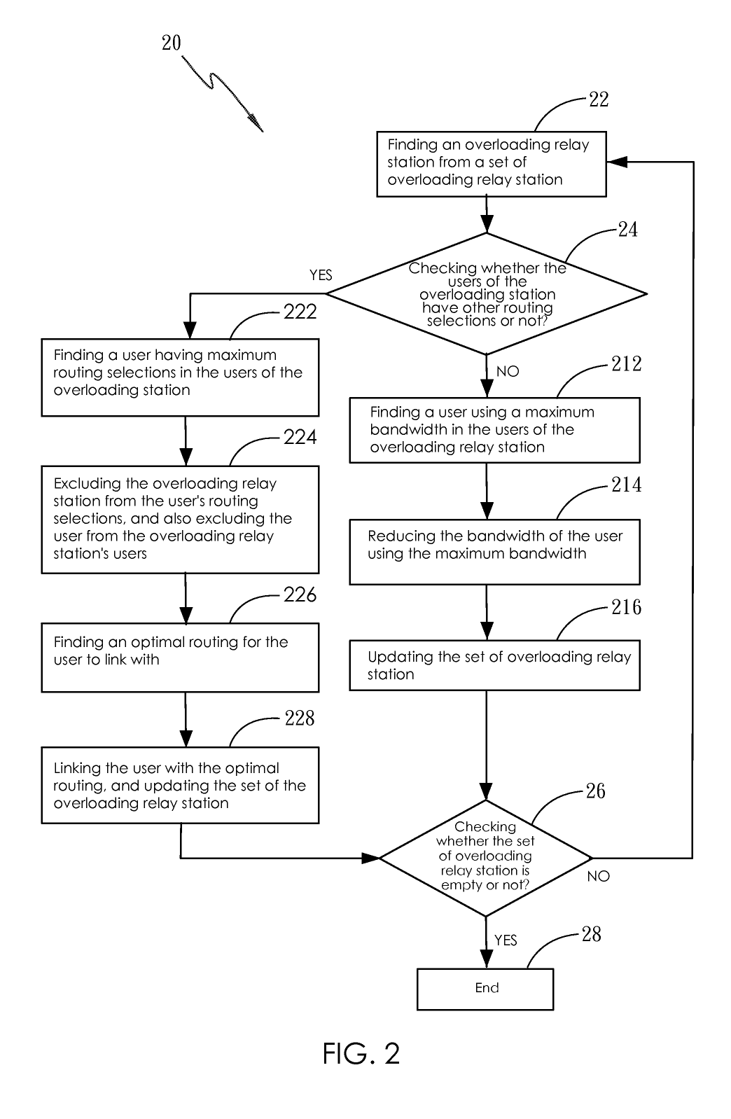

Referring to FIG. 2, a flowchart for one preferred embodiment 20 in accordance with the present invention is illustrated. In step 22, a base station finds an overloading relay station from a set of overloading relay station. Wherein, the set of overloading relay station is an overloading list recorded by the base station, and it means there is(are) relay station(s) in overloading status waiting to be solved in this embodiment while the set of overloading relay station is not empty. In step 24, the overloading relay station checks whether its users have other routing selections or not? Wherein, the abovementioned other routing selections include at least one un-overloading relay station to form an un-overloading relay station group, and the un-overloading relay station group could have at least one relay station linking with the same base station or a different base station.

If all the users of the overloading relay station have no additional routing selection, then step 212 is performed. In step 212, the overloading relay station finds a user using a maximum bandwidth in the users of the overloading relay station. In step 214, the overloading relay station decreases the bandwidth of the user using the maximum bandwidth. Wherein, the method for reducing the bandwidth of the user using the maximum bandwidth could be to reduce the bandwidth of the user using the maximum bandwidth by a predetermined value to reduce the use of bandwidth of the overloading relay station, and also could be to multiply the bandwidth of the user using the maximum bandwidth by a predetermined percentage to reduce the use of bandwidth of the overloading relay station. In step 216, the base station updates the set of overloading relay station. Wherein, the overloading relay station is removed from the overloading list recorded by the base station when its overloading problem is solved. That is, the overloading relay station is excluded from the set of overloading relay station.

In step 26, the base station checks whether the set of overloading relay station is empty or not? When the set of overloading relay station is not empty, it means there is (are) relay station(s) in overloading status waiting to be solved in this embodiment, and then the processes repeats from step 22. However, when the set of overloading relay station is empty, all the processes mentioned above are to be ended in step 28.

If at least one user of the overloading relay station has another routing selection, then step 222 is carried out. In step 222, the overloading relay station finds a user having maximum routing selections from its users. In step 224, the overloading relay station is excluded from the user's routing selections, and the user is also removed from the overloading relay station's users. That is, the overloading relay station disconnects the routing link between itself and the user to reduce the use of bandwidth thereof. In step 226, the base station finds an optimal routing to link to the user. Wherein, the optimal routing is based on an optimal communication channel, in some cases, the optimal routing could be the shortest routing, but in other cases, the optimal routing could not be the shortest routing. Further, the optimal routing can be determined by the steps as follows: comparing the time (a first time) for the user passing through the routing link (a first routing) of the overloading relay station and the time (a second time) for the user passing through the routing link (a second routing) of an un-overloading relay station, when the difference between the first time and the second time is smaller than a predetermined threshold, the routing link of the un-overloading relay station is the optimal routing for the user. In step 228, the user chooses the optimal routing to link to, and the base station updates the set of the overloading relay station. And then, the processes repeats from step 26, and the details, here, will not be described again.

The inventor would like to clarify that the user and the user group mentioned in this invention should not be limited in end-user communication devices only and they could be relay communication equipments as well. For example, the user and the user group could be communication devices or relay stations.

The comparisons for the simulations, such as system capacity, transmission power, and outage probability, among embodiments of this invention and well-known techniques are described below. The inventor would like to emphasize that the related data set for simulations and the results obtained from simulations are used to explain the simulation processes and the results of embodiments in accordance with this invention, but not limit the implementing of this invention. Let the system (e.g. a multihop cellular system) bandwidth be 300 MHz, and the transmission data rates be 1 M, 800 k, 600 k, 400 k, and 200 k bits per second that uniformly distributed among all users. Furthermore, most of throughput gains can be obtained with the use of a two- or three-hop relaying scheme (J. Cho and Z. J. Hasa, “On the throughput enhancement of the downstream channel in cellular radio networks through multihop relaying,” IEEE J. Sel. Areas Commun., vol. 22, pp. 1206-1219, September 2004.), therefore the maximum number of hops for each user can be reasonably set as three. The prescribed threshold of the overall bit error rate (BER) is set to be 10⁻⁵. The multihop cellular system with either 10 or 20 relay stations is considered.

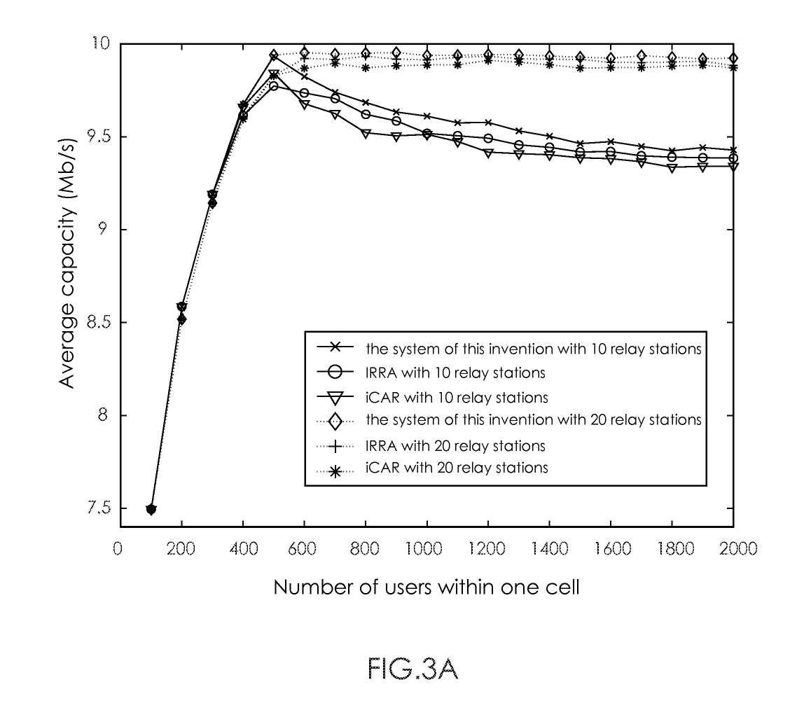

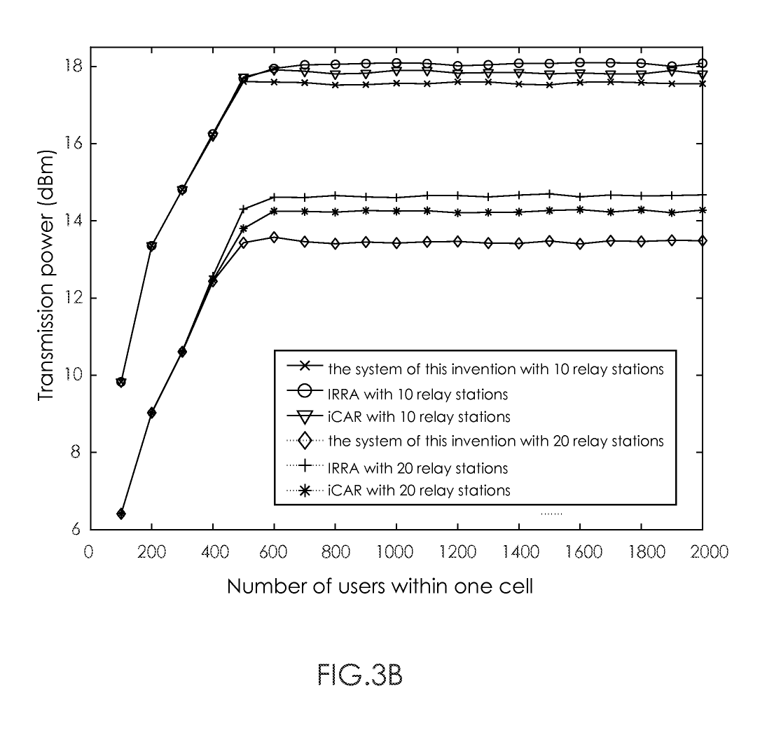

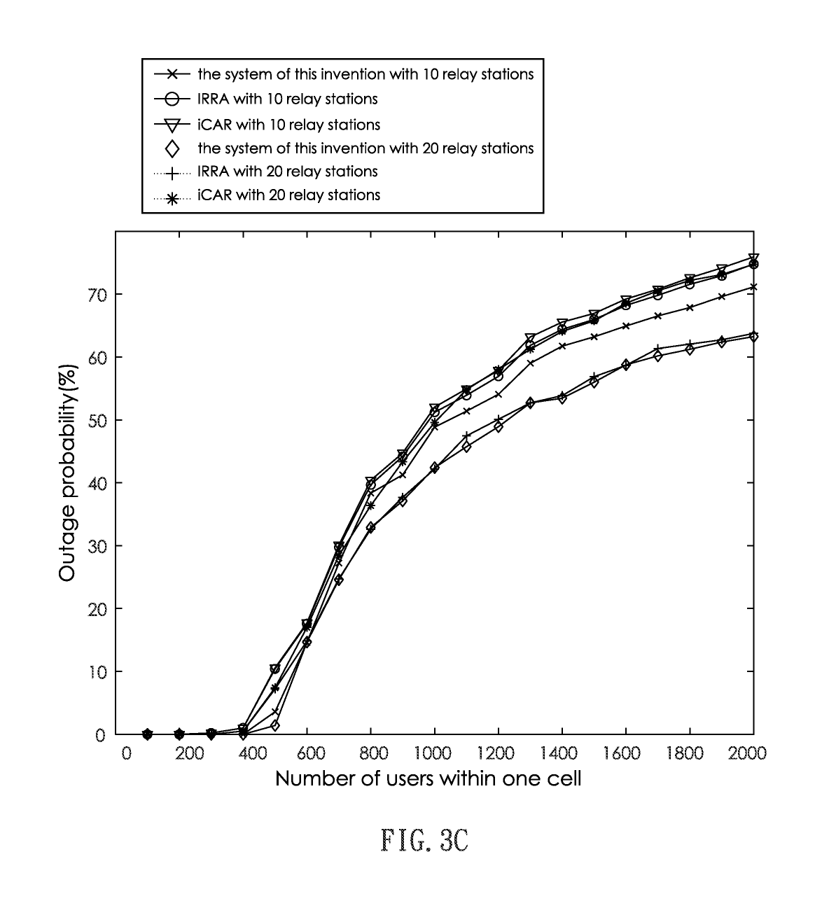

Referring to FIG. 3A, the comparisons of the capacity regarding number of users for preferred embodiments of this invention and well-known schemes are illustrated. Notice that the relay stations have no overloading problem as the number of users is under 300. However, once the number of users is more than 300, the overloading event occurs. The capacities of the embodiments of this invention in 10 or 20 relay stations outperform those of other two schemes in 10 or 20 relay stations owing to the fact that the integrated radio resource allocation (IRRA) scheme reduces solely the data rates of the users, while the integrated cellular and ad hoc relaying (iCAR) only executes its primary and secondary relaying without taking the channel impact into account. Moreover, the IRRA performs better than the iCAR regarding capacity, which implies that the multihop cellular system suffers larger influence on the channel selection than the transmission data rate.

Referring to FIG. 3B, the comparisons of the transmission power regarding number of users for preferred embodiments of this invention and well-known algorithms are depicted. As the overloading problem occurs, the transmission power becomes saturated, and the embodiment of this invention displays a better performance than IRRA and iCAR regardless of whether the number of relay stations is 10 or 20.

Referring to FIG. 3C, the comparisons of the outage probability regarding number of users for preferred embodiments of this invention and well-known designs are shown. Both the embodiments of this invention and the IRRA can accommodate more users whether the number of relay stations is 10 or 20, and that is, they possess a lower outage probability than the iCAR does with 10 or 20 relay stations. In addition, the embodiments of this invention execute the “user switched” step first as the overloading problem occurs, followed by the data rate reduction. This can release more bandwidth to the other potential users and make its outage probability better than the IRRA's.

Although specific embodiments have been illustrated and described, it will be obvious to those skilled in the art that various modifications may be made without departing from what is intended to be limited solely by the appended claims.

What is claimed is:

1. A method for selecting routing and cancelling overloading in multihop cellular systems, said method comprising:
(a) finding a user group having a plurality of routing selections from an overloading relay station, wherein the number of user in said user group is not zero;
(b) finding a user having maximum routing selections from said user group, wherein the routing selections of said user include at least one un-overloading relay station group;
(c) disconnecting the routing link between said overloading relay station and said user to reduce the use of bandwidth of said overloading relay station; and
(d) finding an optimal routing from said at least one un-overloading relay station group to link said user.

2. The method according to claim 1, when the number of user in said user group is zero, said method comprises the steps as follows:
(e) finding a user using a maximum bandwidth in the users of said overloading relay station; and
(f) reducing the bandwidth of said user using said maximum bandwidth to reduce the use of bandwidth of said overloading relay station.

3. The method according to claim 2, when the routing selections of said user have no said at least one un-overloading relay station group, said method comprises the steps as follows: step (e) and step (f).

4. The method according to claim 3, when the use of bandwidth of said overloading relay station is still overloaded, said method comprises the steps as follows: step (a); step (b); step (c); step (d); step (e); and step (f).

5. The method according to claim 4, wherein said overloading relay station belongs to an overloading relay station group, and when the number of overloading relay station in said overloading relay station group is not zero, said method comprises the steps as follows: step (a); step (b); step (c); step (d); step (e); and step (f).

6. The method according to claim 1, wherein step (c) comprises the steps as follows:
excluding said user from the users of said overloading relay station; and
excluding said overloading relay station from the routing selections of said user.

7. The method according to claim 1, wherein step (d) comprises the steps as follows:
comparing a first time measured from by passing a first routing of said overloading relay station and a second time measured from by passing a second routing selecting from said at least one un-overloading relay station group, said second routing is said optimal routing when a difference between said first time and said second time is smaller than a predetermined threshold.

8. The method according to claim 1, wherein said optimal routing is a shortest routing.

9. The method according to claim 1, wherein said optimal routing is a routing with an optimal communication channel.

10. The method according to claim 2, wherein step (f) comprises the steps as follows:
reducing the bandwidth of said user using said maximum bandwidth by a predetermined value to reduce the use of bandwidth of said overloading relay station.

11. The method according to claim 2, wherein step (f) comprises the steps as follows:
multiplying the bandwidth of said user using said maximum bandwidth by a predetermined percentage to reduce the use of bandwidth of said overloading relay station.

12. The method according to claim 1, wherein said user group comprises communication devices and/or other relay stations.

13. The method according to claim 1, wherein said at least one un-overloading relay station group comprises at least one relay station linking with a same base station and/or a different base station.

14. A system for selecting routing and cancelling overloading in multihop cellular systems, said system comprising:
a plurality of relay stations, linking with a base station to form a multihop cellular network, wherein when at least one relay station in said plurality of relay stations is overloaded, said system performs the steps as follows:
(a) finding a user group having a plurality of routing selections from said at least one relay station, wherein the number of user in said user group is not zero;
(b) finding a user having maximum routing selections from said user group, wherein the routing selections of said user include at least one un-overloading relay station group;
(c) disconnecting the routing link between said at least one relay station and said user to reduce the use of bandwidth of said at least one relay station; and
(d) finding an optimal routing from said at least one un-overloading relay station group to link said user.

15. The system according to claim 14, when the number of user in said user group is zero, said system performs the steps as follows:
(e) finding a user using a maximum bandwidth in the users of said at least one relay station; and
(f) reducing the bandwidth of said user using said maximum bandwidth to reduce the use of bandwidth of said at least one relay station.

16. The system according to claim 15, when the routing selections of said user have no said at least one un-overloading relay station group, said system performs the steps as follows: step (e) and step (f).

17. The method according to claim 16, when the use of bandwidth of said at least one relay station is still overloaded, said system performs the steps as follows: step (a); step (b); step (c); step (d); step (e); and step (f).

18. The system according to claim 14, wherein step (c) comprises the steps as follows:
excluding said user from the users of said at least one relay station; and
excluding said at least one relay station from the routing selections of said user.

19. The system according to claim 14, wherein step (d) comprises the steps as follows:
comparing a first time measured from by passing a first routing of said at least one relay station and a second time measured from by passing a second routing selecting from said at least one un-overloading relay station group, said second routing is said optimal routing when a difference between said first time and said second time is smaller than a predetermined threshold.

20. The system according to claim 14, wherein said optimal routing is a shortest routing.

21. The system according to claim 14, wherein said optimal routing is a routing with an optimal communication channel.

22. The system according to claim 15, wherein step (f) comprises the steps as follows:
reducing the bandwidth of said user using said maximum bandwidth by a predetermined value to reduce the use of bandwidth of said at least one relay station.

23. The system according to claim 15, wherein step (f) comprises the steps as follows:
multiplying the bandwidth of said user using said maximum bandwidth by a predetermined percentage to reduce the use of bandwidth of said at least one relay station.

24. The system according to claim 14, wherein said user group comprises communication devices and/or other relay stations in said plurality of relay stations.

25. The system according to claim 14, wherein said at least one un-overloading relay station group comprises at least one relay station linking with said base station and/or a different base station.
